(19) United States
(12) Patent Application Publication
(10) Pub. No.: US 2009/0206170 A1
(43) Pub. Date: Aug. 20, 2009

(54) Mitigation of rotating wind storms

(76) Inventor: Horace Randolph Crawford, Katy, TX (US)

Correspondence Address: William D. Harris, Jr., Suite 1200, 5400 LBJ Freeway, Dallas, TX, 75240, US

(21) Appl. No.: 12/070,870

(22) Filed: Feb. 20, 2008

(51) Int. Cl. A01G 15/00

(52) U.S. Cl. 239/2.1; 137/1; 239/14.1

(57) ABSTRACT

A method for mitigating or preventing a major air disturbance comprising a fluid stream, preferably heated, adjacent to the earth's surface and orienting it upwardly in the vicinity or potential vicinity of a major air disturbance in order to in part move lower level air upwardly to cool the surface of the earth, including the sea. The displacement of atmospheric air by the upwardly directed stream diminishes the strength or potential strength of major air disturbances.

### FIELD OF THE INVENTION

The field of the invention is a method of mitigating rotating wind storms, particularly tornadoes and hurricanes.

### BACKGROUND OF THE INVENTION

The background of the invention is believed to be a matter of first impression, conceived by the inventor. There is no known materially related art on such mitigation.

While there are various theories concerning the formation of tornados, and to a lesser extent to the formation of hurricanes, there is a need for a method to mitigate these ugly giants and to accomplish such mitigation. No other method of mitigation is known. Seeding the pertinent area from the sky with ice crystals and chemicals, such as dry ice, silver iodide, explosion rockets, calcium chloride, pumped sea water, micro dust, and carbon black has been tried but does not yield noteworthy results.

Moreover, in a laboratory environment it has been indicated that a special rotating kind of thunderstorm could be split into two. Also there has been attempts to lift fog by blowing it away with special airplane engines.

On the other hand, there is considerable literature on the formation of and the destruction wrought by tornadoes and hurricanes and various hypotheses for their formulation and very nature. The devastation caused by these killer twisting, rotating storms when they are full blown is well known.

### SUMMARY OF THE INVENTION

This invention presents methods to mitigate the damage done by tornados and hurricanes. The practice of the methods initiate additional man-made “relief tornadoes or hurricanes” (rotating wind storms) that will provide one or more additional parallel paths to relieve the atmospheric imbalance. Note that having more than one path will decrease the strength of the natural tornado, and cool the surface of the earth or ocean to decrease the energy available to a future tornado or hurricane that comes near the path of man-made relief tornados or hurricanes

In general, tornadoes and hurricanes develop with a low pressure center and are probably being fed by warm and often moist air from the earth's surface in the case of tornadoes or from the ocean surface in the case of hurricanes.

The present invention takes the bold step of forming tornados or tornado like windstorms as well as forming hurricanes or hurricane like disturbances to decrease or minimize the strength of a “natural tornado,” or to decrease or minimize hurricane force, respectively.

When man-made tornadoes are in close proximity to a natural tornado the strength of the latter will dissipate. Also when man-made tornadoes are formed in front of a tornado or hurricane path, the strength of the natural tornado will be diminished. Sometimes a plurality of man-made rotating wind storms may be used to more effectively diminish natural tornado strength or natural hurricane strength.

The man-made tornadoes are formed by directing one or more heat columns or paths upward. These heat columns are referred to herein as columns or chimneys.

Some of these man-made tornadoes are formed in the proximity to the devastating rotating wind. Other man-made rotating winds may be near the future path of the devastating disturbance.

A preferred method of initiating a tornado or hurricane is by directing a heat column upwards by running a powerful aircraft type jet engine near where a relief tornado or hurricane is desired. This jet engine can be thought of as a combination of a heater plus a compressor or a fan. Each of these, if the energy release rate is at least about the same as that of an aircraft type jet engine being run at high thrust, can individually help create a heat column or chimney that can initiate a relief tornado or hurricane. The combination of heater and a fan or a compressor, exemplified by an aircraft type jet engine, whose exhaust is released to travel upwards, is desirable.

### DETAILED DESCRIPTION OF THE INVENTION

A device for initiating a mitigating tornado can be truck mounted with at least one aircraft type jet engine e.g., the engines such as or used on a 707, 727, 747 aircraft etc., and larger or smaller. Usually, the jet engine has its exhaust pointed mostly upward, e.g. usually within 45 degrees of the vertical. When a natural tornado materializes, or is expected, the vehicle is located close to the tornado, or its expected path. e.g., if a cell cloud is incident to the tornado, then the vehicle is located in or near to the cell cloud.

The jet engine draws air from around the relatively hot earth and further heats the air and imparts a relatively high upwards velocity to the warm air to form a chimney or column of relatively warm air along the projected path of the exhaust. The relatively warm air displaces the cooler air as it goes upward and forms a selectively small tornado which herein is referred to as man made or artificial. This artificial tornado robs the strength of the natural tornado. There are then two tornadoes, but the relative strength of each is less than the original strength of the natural tornado.

As a practical matter a plurality or multiplicity of mitigating tornadoes is preferred to materially mitigate the power of each, including principally the natural tornado. The use of numerous trucks with operating jet engines and discharging at least partly upwards may cause the formation of multiple mitigating tornados.

The tornado initiator is sent to an area where the Weather Bureau has identified a tornado or the likelihood of a tornado. The initiator crew drives the initiator to the identified area and runs the jet engine at high thrust, with exhaust pointed upward, for about 0.1 minute to about 20 minutes, or longer.

It is preferred to have multiple relief tornadoes, to diminish the strength of the natural tornado and to minimize the likelihood that a relief tornado might get out of control. These multiple tornadoes are created while the jet engines are run at a high thrust with its discharge aimed at least partly upwards.

The present invention also has application to hurricanes. By way of example, a rising chimney of warm moist air is again utilized. An airplane jet engine is mounted on a boat or other weather craft. One or more of such jet engine mounted boats are dispersed in the area close to the front, or the expected path, of the hurricane. The jet engines may also be mounted on land near the ocean that is near the expected path of a hurricane. The jet engines (e.g., perhaps ten, more or less) are fired and there are two results: a chimney or column of warm moist air rises, where it displaces cooler air and the water nearby is cooled. Both of these factors militate against the power of the natural hurricane. Thus, a hurricane is cut down to a lower strength number. For example, it is theorized that daily jet engine firing between the African Coast and Cuba would reduce the number of high strength hurricanes, and particularly those of Cat. 3 and above.

The column or chimney forming hardware is not meant to be limited to jet engines. Heated and even intense unheated fans or propellers, or like devices pointed upwardly may be used.

The prophetic nature herein is caused by two factors: The nature of the invention is such that it would likely be practiced under government auspices, particularly in view of the possibility of a man-made rotating wind getting out of control; and both tornadoes and hurricanes are formed and maintained under conditions not well understood and that may be the subject of conflicting theory.

It is not possible for the inventor, or indeed anyone else, to give a theory that is guaranteed to be accurate concerning operation of the present invention, and of the detailed nature of formation and operation of natural tornadoes and hurricanes. In the hopes that it will be useful to those of ordinary skill in the art, it is hereby elected to furnish a theory suggested by the inventor. Without professing to be a theory that in any way limits the present invention, a possible theory regarding tornadoes and hurricanes and with man-made “relief chimneys” that may safely dissipate some of the energy that would otherwise be available to add to the destructive ability of a “natural tornado” or hurricane is now offered.

It is theorized here that a tornado or a hurricane is likely to form and/or grow whenever there is a layer of less dense air that is below a layer of more dense air. This situation is unstable. The less dense air must rise until it is on top. The more dense air must move down until it is below the less dense air.

A tornado is more likely to form and to be more severe if:
The lower layer is less dense, or warmer, more humid, or has more enthalpy (heat energy);
The upper layer is more dense, or cooler, or drier, or contains less enthalpy; and
The aerial extent of the unstable layers is larger and the difference between the density,
temperature, humidity and enthalpy of the lower and upper layers is greater.

It would improve our ability to predict a tornado or hurricane if we measure, or at least have access to, the data concerning the foregoing.

As seen from above, the rising column normally rotates counter-clockwise north of the Equator and clockwise south of the Equator. This rotating, or whirling, column of rising warm air is what is known as a tornado if on land and a hurricane if over the sea.

Nature tends to honor the hot air to rise and the cool air to decline. Vertical and horizontal as well as rotational circulations are created by these instabilities. The whirling “chimneys” have more energy if the extent of the instability is larger, that is if there is more or hotter land or water surface. Once a tornado or hurricane starts, it tends to grow and become larger if it can draw energy from the heated surface and if it can establish a vertical pathway to let the rising air to go all the way to the upper layers of cool heavier air.

A natural tornado and a hurricane, as well as a man-made relief chimney, will cool the surface of the land or ocean as it passes over them. This cooling reduces the energy available to a future tornado or hurricane that would traverse a similar path, for some period of time after these tornados; hurricanes or relief chimneys have traversed such path.

The present invention presents a way to provide more, but smaller, pathways to allow the atmospheric instabilities to relieve them thereby “robbing” the natural tornados or hurricanes of some of the energy they need to become large and more damaging. The more the number of whirling updrafts, the less energy and less potential for damage is available in each.

As a result of practice of the present invention, and as explained above, the invention presents a way to diminish the energy available to a present or future tornado or hurricane.

Moreover, it is theorized that the initiation of relief chimneys would cause some cooling naturally of the land or the ocean over which they traversed thereby making some amount of energy unavailable to a future tornado or hurricane.

As heretofore stated, it is not my intention to be bound or limited and by any theory expressed or to be limited to any such theory.

Having described specific embodiments of the present invention, it will be understood that modifications thereof may be suggested to those skilled in the art, and it is intended to cover all such modifications as fall within the scope of the appended claims.

1. Forming a warm stream, directing the stream substantially upwardly toward the sky from the earth's surface in the vicinity of a major air disturbance in which high velocity rotating winds are present thereby moving lower level air upwards, thus cooling the surface of the earth and displacing the air above; whereby said action diminishes the strength of the air disturbance.

2. The method of claim 1 wherein the air disturbance is a tornado.

3. The method of claim 1 wherein the air disturbance is a hurricane and the surface of the earth cooled comprises water.

4. The method of claim 1 wherein the air disturbance is a developing hurricane.

5. The method of claim 1 wherein one or more warm chimneys are directed upwardly to cool the surface of the earth and displace cold air above in selected geographical areas to diminish hurricane potential.

6. The method of claim 5 in which said chimney is formed by a jet engine.

7. The method of claim 1 in which a multiplicity of jet engines form multiple chimneys that are spaced apart.

8. The method of claim 1 in which a prophylactic measure is used to provide one or more relief chimneys at least as often as between daily and weekly in the part of the oceans in which natural hurricanes are spawned.

9. Initiating the formation of relief chimneys of rising, whirling air in the close proximity of a rotating wind storm, or in the proximity of the predicted path of a rotating windstorm including incipient tornadoes and hurricanes.

10. A method for mitigating the effect of a rotational air disturbance in the atmosphere comprising:
forming a stream of comparatively warm fluid adjacent to the earth's surface orienting said stream along an axis extending upwardly in the atmosphere from the earth's surface in the vicinity of a major air disturbance in which high velocity rotational winds are present, thereby moving lower level air upwards thru the atmosphere to cool the surface of the earth and displace atmospheric air above the surface of the earth whereby said upwardly directed warm stream diminishes the strength of the major air disturbance.

11. The method of claim 10 in which as a prophylactic measure a plurality of streams are formed at least weekly intervals in a geographic location in which natural hurricanes are known to be spawned.

12. The method of claim 5 wherein said chimney is formed by a heater, or a fan, or a compressor, from which the energy release rate is at least about the same as the energy release rate from an aircraft type jet engine being run at high thrust.
